(19) United States
(12) Patent Application Publication
(10) Pub. No.: US 2003/0158738 A1
(43) Pub. Date: Aug. 21, 2003

(54) SYSTEM AND METHOD FOR PROVIDING TRAVEL SERVICE INFORMATION BASED UPON A SPEECH-BASED REQUEST

(76) Inventors: CAROLYN CROSBY, KELLER, TX (US); KEVIN BOMAR, WEATHERFORD, TX (US)

Correspondence Address: ALSTON & BIRD LLP, BANK OF AMERICA PLAZA, 101 SOUTH TRYON STREET, SUITE 4000, CHARLOTTE, NC, 28280-4000, US

(21) Appl. No.: 09/431,077

(22) Filed: Nov. 1, 1999

(51) Int. Cl. G10L 21/00

(52) U.S. Cl. 704/275

(57) ABSTRACT

A method and apparatus for processing travel-related speech input is presented. A travel server receives a speech input corresponding to a travel-related task. The travel server then converts the speech input into data reflecting the travel-related task and accesses a database for stored information corresponding to the travel-related task. This stored information is returned to the source of the speech input.

### FIELD OF THE INVENTION

The present invention relates to the field of computerized reservation systems such as airline reservation systems used by airline ticket agents and travel agents. More particularly, the invention relates to a speech travel application allowing for the shopping and booking of specific travel plans.

### BACKGROUND OF THE INVENTION

A computerized reservation system (CRS) provides a communications network for travel agents and other users to book airline reservations. Travel-related businesses and other companies may interface their computer systems with a CRS in order to make information concerning their services available via the CRS. For example, a hotel company may interface its reservation system with a CRS so that when a person books an airline reservation, he or she may also make a hotel reservation through the same network.

The major computerized reservation systems currently in use throughout the world share a common heritage. They also have common business assumptions that were true nearly two decades ago. Examples of such reservation systems are known or referred to under the following trade names and service marks: SABRE; AMADEUS; WORLDSPAN; SYSTEM ONE; APOLLO; GEMINI; GALILEO; and AXESS. Under these systems, a customer chooses an itinerary, based on their desired travel dates and times, and books the itinerary through the CRS.

Presently, there are systems that work in conjunction with CRS to aid a user in making reservations. An example of such a system is the Business Travel Solutions (BTS) product. With this product, a user would log into a web browser and access the BTS travel application using a unique password through typing or clicking of the mouse. When the user types the preferred criteria, the application requires the user to go down a specific path every time to get the requested information. For example, the BTS application could force a user to drag down specific menus in order to find the desired information. This method of retrieving travel information does not provide the flexibility of jumping into other search criteria for air, hotel, or car. Once a user starts down a specific path, the path must be completed. Retrieving information in this manner requires a user to think in a way that is not very natural.

Accordingly, there is presently a need for a system or process for retrieving travel information in a more natural manner.

### SUMMARY OF THE INVENTION

A method consistent with the present invention processes travel-related speech input in a network having a travel server. The travel server receives a speech input corresponding to a travel-related task, converts the speech input into data reflecting the travel-related task, accesses a database for stored information corresponding to the travel-related task, and returns the stored information.

An apparatus consistent with the present invention processes travel-related speech input. The apparatus includes means for receiving a speech input corresponding to a travel-related task, means for converting the speech input into data reflecting the travel-related task, means for accessing a database for stored information corresponding to the travel-related task, and means for returning the stored information.

Another apparatus consistent with the present invention provides travel-related information. A user interface includes a first view showing text indicative of a speech input corresponding to a travel-related task. This speech input was received by a travel server connected to the user interface and converted into data reflecting the travel-related task. The user interface also includes a second view showing stored information corresponding to the travel related task. The travel server accessed a database to retrieve the stored information and returned the stored information to the user interface. Lastly, the user interface includes a third view showing a map corresponding to the stored information.

### BRIEF DESCRIPTION OF THE DRAWINGS

The accompanying drawings are incorporated in and constitute a part of this specification and, together with the description, explain the advantages and principles of the invention. In the drawings,

FIG. 1 is a diagram of an exemplary computer network environment in which the features and aspects of the present invention may be implemented;

FIG. 2 is an exemplary data processing system consistent with the present invention;

FIG. 3 is another exemplary data processing system consistent with the present invention;

FIG. 4 is an exemplary flow chart of a process for processing travel-related speech input consistent with the present invention; and

FIGS. 5A, 5B, 5C are exemplary user interfaces consistent with the present invention.

### DETAILED DESCRIPTION

The following detailed description of the invention refers to the accompanying drawings. While the description includes exemplary embodiments, other embodiments are possible, and changes may be made to the embodiments described without departing from the spirit and scope of the invention. The following detailed description does not limit the invention. Instead, the scope of the invention is defined by the appended claims and their equivalents.

The speech travel application of the present invention provides for an easy to use system for making travel plans. Input via speech recognition enables users of the system to interactively shop and book travel assets via flat speech statements or directed dialog using telephony or a PC microphone. The speech travel application thus allows the user to shop for travel based on a visual representation of destination information.

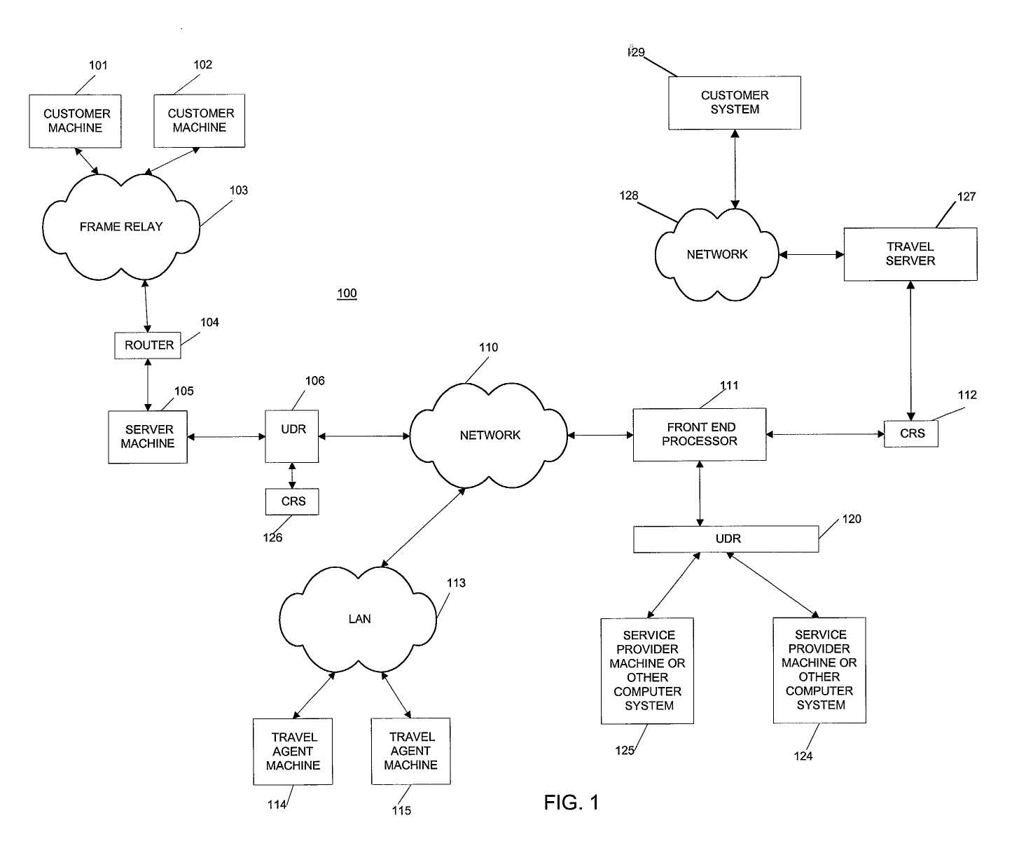

FIG. 1 is a diagram of a network environment 100 including one or more CRS. CRS are networks permitting access to, for example, travel-related information for making reservations or obtaining such information. CRS may use and provide other types of information, depending upon the computer systems interfaced with a particular CRS or the information accessible by the CRS. CRS are commonly referred to as computer reservation systems or central reservation systems. In European countries, for example, CRS are often referred to as global distribution systems. The term “computerized reservation system” and the abbreviation “CRS” are intended to encompass computerized reservation systems, computer reservation systems, central reservation systems, and global distribution systems. Examples of CRS include those known by the following trade names and service marks: SABRE; AMADEUS; WORLDSPAN; SYSTEM ONE; APOLLO; GEMINI; GALILEO; and AXESS.

Network environment 100 illustrates how customers or service providers may be linked together through computerized reservation systems, such as CRS 112 or 126. For example, customer machines 101 and 102 may represent machines located at a particular business or other entity for providing travel-related and other services for that business or entity. Customer machines 101 and 102 are typically interfaced through a frame relay 103 and a router 104 to a server machine 105. Router 104 provides for routing of a protocol over frame relay 103 for long distance communication. Server machine 105 provides necessary interaction between the ultimate customer machines and a CRS, for example, CRS 126.

Server machine 105 is typically interfaced through a universal data router (UDR) 106 to a network 110. UDR 106 may include several servers, as explained below, for performing data conversion for server 105 to communicate with a CRS, for example, CRS 126. Network 110 may represent a private network such as the Societe Internationale Telecommunications Aeronautiques (SITA) network. Network 110 interfaces UDR 106 with a front end processor 111, which provides an interface to a CRS 112. A CRS usually includes a front end processor, which are known mainframe components, providing functionality for interfacing the CRS with a network. Customer machines 101 and 102 may also be interfaced with other CRS's through UDR 106. Therefore, when a person at customer machine 101 or 102 desires to, for example, book a travel-related reservation or access other types of information, a communications link is established through the various elements between the customer machine and CRS 112 or 126.

In addition, network 110 may interface travel agent machines 114 and 115 with CRS 112 or 126. In particular, network 110 may interface a local area network (LAN) 113 connected to travel agent machines 114 and 115. Travel agent machines 114 and 115, if located overseas, may also be linked into CRS 112 or 126. In such a case, network 110 may interface token ring LAN 113 through an international telephone or computer network (not shown).

Other companies or service providers may also provide information available via CRS 112. Such information may be provided, for example, by interfacing service provider machines or other computer systems 124 and 125 through UDR 120 to front end processor 111. UDR 120, which may include several servers, provides data conversion to interface the service provider machines 124 and 125 in accordance with the protocol used by CRS 112. Alternatively, service provider machines 124 and 125 may interface with UDR 106 and/or CRS 126.

CRS 112 may also be connected to travel server 127. Travel server 127 implements the present invention in conjunction with customer system 129. Travel server 127 may be connected to customer system 129 through network 128.

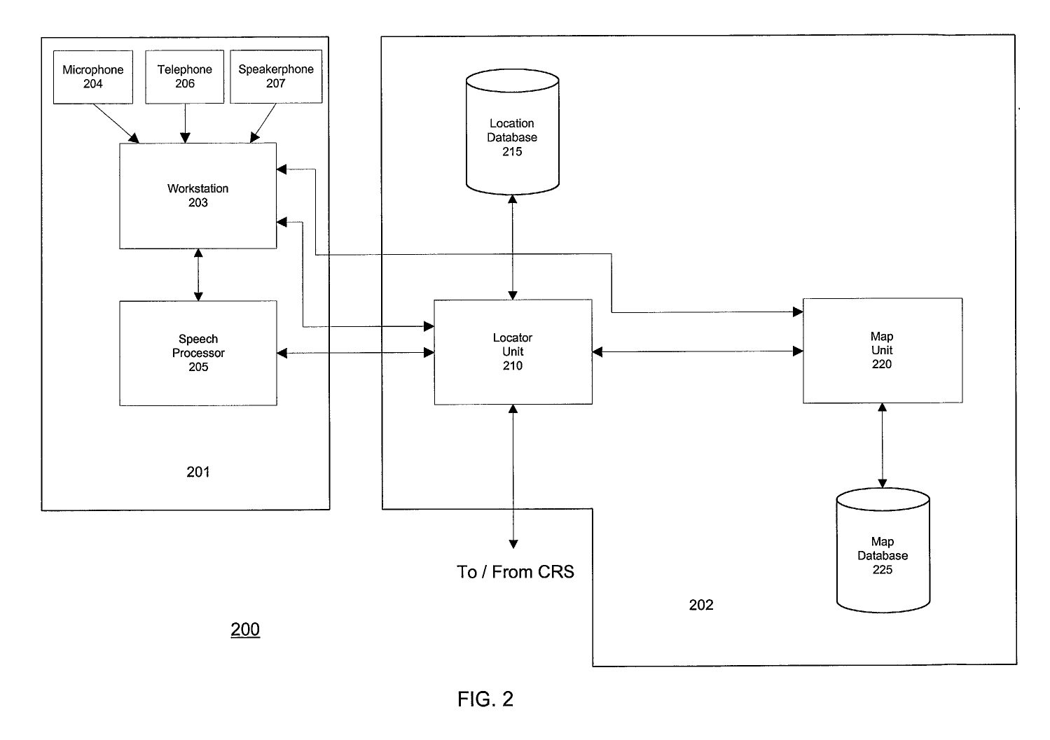

FIG. 2 is an exemplary data processing system 200 which implements the operations and processes of the present invention. Data processing system 200 comprises a customer system 201 and a travel server 202 connected to each other using connections that may be network connections. For example, customer system 201 and travel server 202 may be connected to each other in the manner shown in FIG. 1 (i.e. customer system 129 is connected to travel server 127 through network 128). The functionality of customer system 201 may be placed on any of the end user systems/stations shown in FIG. 1 (i.e. customer machine 101, travel agent machine 114, service provider machine 125). The functionality of travel server 202 may be placed on any of the servers or front end processors shown in FIG. 1 (i.e., server machine 105, front end processor 111, travel server 127).

Customer system 201 is responsible for accepting speech input from a user and parsing that input to extract relevant travel data which it can then send to a processor to perform a search based on that travel data. In one embodiment, customer system 201 preferably includes workstation 203 (or other user computer/PC). Workstation 203 preferably runs a web browser such as Internet Explorer or Netscape Navigator and is capable of accepting speech input from a device that is connected to workstation 203. For example, speech input can be provided to workstation 203 via microphone 204, telephone 206, or speakerphone 207 that are each communicably attached to workstation 203. This speech input is passed to speech processor 205 which is connected to workstation 203. Workstation 203 also includes a graphical user interface that is capable of displaying list of assets that meet search criteria, and a map that actually displays assets that matched the criteria.

Speech processor 205 is preferably a speech recognition engine that has natural language understanding functionality. For example, speech processor 205 could be implemented using a speech recognition system available from Nuance. Such a speech processor does not use an enrollment process to ensure correct speech recognition. Instead, the user gets trained by the system subconsciously through normal use of the system. Speech processor 205 takes speech input from workstation 203 and examines that data in order to extract the data that is needed to conduct a search. The speech input is converted into data that can be processed by the rest of the system. For example, for a search to be conducted using the system of the present invention, type of asset, reference point(s), and geographic operation may need to be extracted from the speech input (not all of these are always necessarily vital to a given search). Type of asset refers to the kind of service that a user is looking for. Examples of types of assets are air, car, hotel, and events. Reference points refer to specific locations, areas, or distances that can be applied to the search. The different types of reference points are: points (e.g., airports, points of interest); strings (e.g., roads, rivers, interstates); polygons (e.g., countries, states, counties, user defined locations); and distance (e.g., within X miles of asset). Geographic operation refers to a word used to indicate what area a search should be inclusive of. Examples of geographic operations are “within” (e.g., airports within 20 miles of Kansas City) and “inside” or “in” (e.g., show hotels in Dallas County). Note that when “within” is used, a radius (e.g., distance) also needs to be provided.

It is also possible to extract other data that may not necessarily be vital to complete a search but may make a given search more specific. Examples of this data include boolean operations and asset qualifiers. The boolean operations that can be used include “not”, “and”, and “or”. These operations can be used to either make a search more specific (e.g., hotels within 30 miles of El Paso not in Mexico; Marriot Hotels in Connecticut and Vermont) or broaden a search (e.g., Days Inn's within 20 miles of Ruidosa or Carsbad). Asset qualifiers refer to anything that further describes the specific type of asset that the user is searching for. For example, a user can request assets based on specific travel vendors such as: Marriot Hotels; American Airlines; Avis; etc. Also, a search can be conducted via class of service, car type, hotel type, etc. (e.g., show me budget hotels in New Orleans). Furthermore, a system can query by price range, time constraints, departure/return date, time of travel, etc. (e.g., I want to see flights from Denver to LAX at 2pm with round trip fares below 200 dollars).

Both workstation 203 and speech processor 205 are connected to travel server 202. Travel server 202 performs some of the various searches that are conducted with the present invention. Travel server 202 includes locator unit 210, location database 215, map unit 220, and map database 225. Locator unit 210 is connected to workstation 203 and speech processor 205 of customer system 201 so that it may receive the data from speech processor 205 that was extracted from the speech input and output asset data that meets the criteria of the speech input to workstation 203. Locator unit 210 is responsible for taking this data and searching location database 215 to determine the assets that satisfy the terms of the speech input. Locator unit 210 can be, for example, the previously known Location Locator product. Location database 215 can be implemented by one or more relational databases that store all of the asset data. This asset data is stored in such a way that the databases can be searched based on geographic location. Location database 215 also stores detailed information on the assets. This detailed information might allow a user to make a more informed decision.

Locator unit 210 is also connected to a CRS (i.e., CRS 112 or CRS 126 of FIG. 1) and to map unit 220. The CRS in this case is used to determine the availability of selected assets. Map unit 220 is connected to map database 225 and workstation 203 and is used to retrieve a map relevant to assets that were determined by locator unit 210. This map is retrieved by map unit 220 from map database 225 and sent to workstation 203 for display. Alternatively, map unit 220 could retrieve the relevant map data from location database 215, eliminating the need for a separate map database.

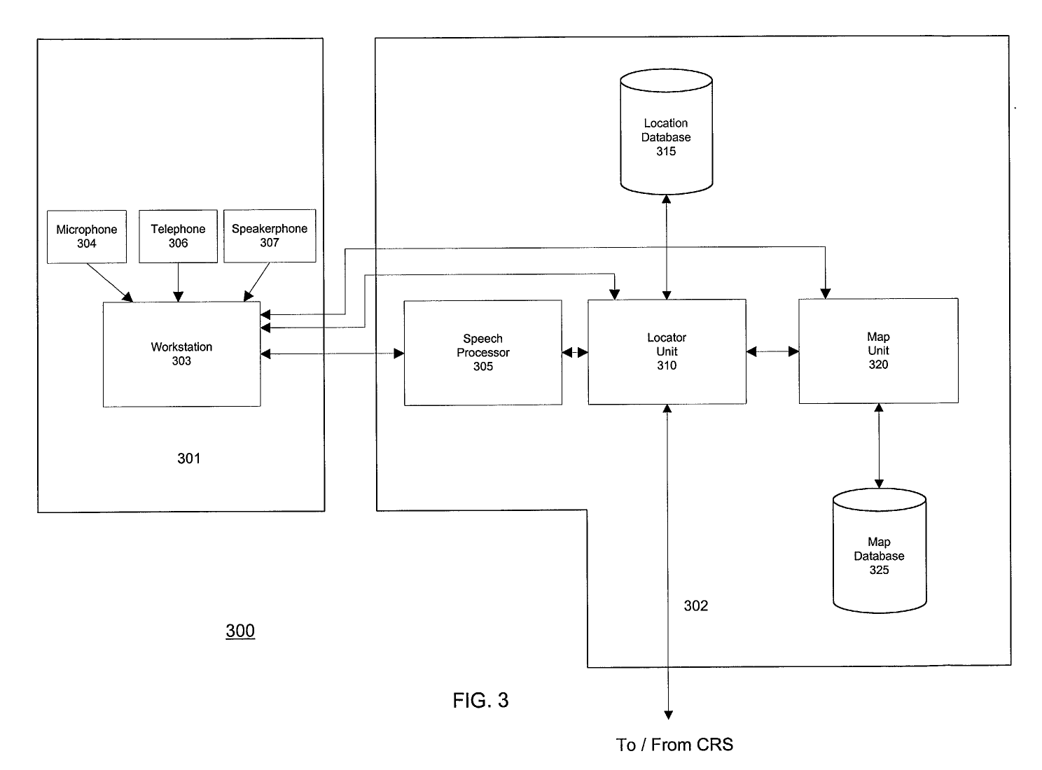

FIG. 3 is another exemplary data processing system 300 which implements the operations and processes of the present invention. Each of the units of FIG. 3 work in the same manner as their corresponding units of FIG. 2 (i.e., workstation 303, microphone 304, telephone 306, speakerphone 307, speech processor 305, locator unit 310, location database 315, map unit 320, and map database 325 operate similarly to workstation 203, microphone 204, telephone 206, speakerphone 207, speech processor 205, locator unit 210, location database 215, map unit 220, and map database 225, respectively). The only difference is that speech processor 305 is located in travel server 302 as opposed to customer system 301. In other words, customer system 301 is only responsible for receiving speech input data and displaying the results. The speech data is sent to a remote location before it is processed. In the description that follows, the referenced parts of FIG. 3 can be interchanged with the corresponding parts of FIG. 2.

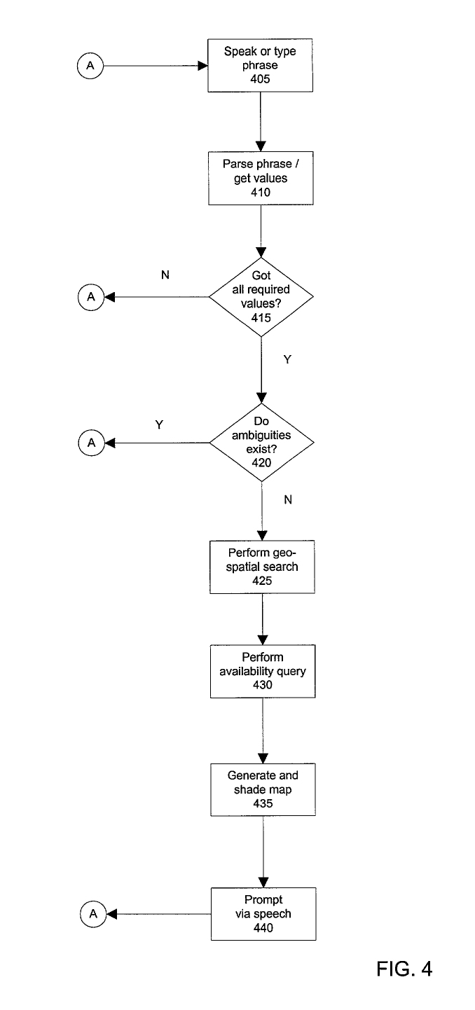

FIG. 4 is an exemplary flowchart of the operation of the speech travel application of the present invention. Before the speech travel application can be utilized, the user must access the system. For example, the user could log into a web browser using workstation 303, then type in a unique uniform resource locator (URL). The URL designates the travel server (i.e., travel server 302). It is possible to utilize some form of security access, so that it would be necessary for the user to enter a password or for some other form of verification to occur. For example, security access can be obtained either by typing or saying a password, speaker verification, or biometric typing. In one embodiment, once the user logs in, the system can retrieve a profile associated with that particular user. This profile can be used to obtain preferences and previously booked itineraries. It also enables personalization of the user's itinerary to include dynamic web content such as weather, flight information, and destination and hotel product information.

Once access has been established, the user must speak or type a phrase (step 405). The user may use microphone 304, telephone 306, or speakerphone 307 for speaking. A keyboard (not shown) associated with workstation 303 may be used to type a phrase. In one embodiment, phrases that are spoken or typed are flat phrases. A flat phrase is a phrase that is not hierarchical in nature. In other words, all of the information that is needed is included in one statement. For example, the phrase, “show me the flights tomorrow from Dallas to San Francisco at 2pm” is an example of a flat phrase. All of the information that is absolutely vital to conducting a search is present in the phrase. Flat phrases are generally preferable to use over directed dialog because they are a more natural way of talking and require less time to specify the different assets. However, there are times when it is necessary for the present invention to use directed dialog, as explained below. Directed dialog is a method of entering data where the system will direct specific questions to a user, and the user will answer those questions. In this manner, the system can determine the necessary criteria for the search.

After the speech data has been entered, workstation 303 sends it to speech processor 305. Speech processor 305 then proceeds to parse the phrase of the speech data and the required values using its natural language understanding functionality (step 410). Specifically, speech processor 305 looks for the various aforementioned criteria (i.e., type of asset, reference points, geographic operation, Boolean operations, and asset qualifiers) and extracts that criteria. This criteria can then be converted into data that can be utilized by the rest of the system. The speech or text that was recognized from the speech data or text input is displayed so that the user can make an initial determination as to whether the input was correctly understood. Once the original phrase has been parsed, a determination is made as to whether or not the speech processor got all of the values that it needs from the phrase (step 415). If all of the required values have not been received, then the user is prompted as to exactly what information was missing from the speech input. For example, if an origin and destination was needed in order to conduct a given search but was inadvertently omitted, the user will be informed that the origin and destination is still needed. This is typically done using directed dialog. The system will specifically ask for certain parameters, and the user will provide input in direct response to those prompts. The user may be prompted using either text on the workstation display or speech output.

If all of the required values have been received, then a determination is made as to whether or not any ambiguities exist in the phrase (step 420). An ambiguity could exist if there are multiple meanings for one or more of the values of the phrase. For example, if a user makes a reference to Portland in a phrase, then the system would be unsure whether the user was referring to Portland, Me. or Portland, Oreg. When such an ambiguity exists, the user is prompted that more information is needed for clarification.

When there are no ambiguities, the phrase has been understood by speech processor 305 and is converted into data that can be processed by the rest of the system. Speech processor 305 transfers all of the relevant data to locator unit 310. Locator unit 310 proceeds to perform a geo-spatial search (step 425) using, for example, the functionality of the location locator product. Location locator is a known application in which at least one database is searched based on various reference points and operators. These points and operators correspond to the values that were extracted by speech processor 305. Location database 315 is the database that is searched by locator unit 310. Note that location database 315 could be replaced by multiple databases if desired. After the search has been completed, the results from the search can be sent back to workstation 303 for display. The results are generally sent to workstation 303 in hyper-text mark-up language (HTML) format and/or extensible mark-up language (XML) format. At workstation 303, lists of hotel property choices, air schedules, car rental locations, destination information, event lists, etc., with an item number beside each item is displayed, along with detailed information on each asset. The detailed information allows a user to make a more informed buying decision.

Also upon completion of the geo-spatial search, locator unit 310 sends the results to a CRS such as CRS 112. The CRS performs an availability query based on the results of the search in order to determine whether a given asset is actually available for booking (step 430). Once an availability determination has been made, data reflecting the availability is sent to workstation 303 for display. The availability can be checked either before or after the original list of assets was displayed.

Next, map unit 320 is utilized to generate and shade a map indicative of the assets that matched the search criteria (step 435). In order to ensure that a proper map is generated, locator unit 310 determines a bounded area that contains all of the assets that matched the criteria. This bounded area is then passed to map unit 320. Map unit 320 uses the bounded area to access map database 325, which returns a map that corresponds to the aforementioned bounded area. Because it is difficult to have a map that is the exact right size for any given bounded area, a section of the map is shaded. The shaded portion of the map represents those areas that are outside of the bounded area. This map is sent to workstation 303 for display. Note that it is also possible to send the map to workstation 303 before the availability of the assets has been determined or at substantially the same time that the list of assets is sent to workstation 303.

After the relevant map has been retrieved and sent to workstation 303, the user is free to select an asset. Dynamic information on assets such as weather, events, and change in details of assets are dynamically sent to travel server 302 and are translated via text to speech so that the user may be told this information (step 440). Alternatively, a recorded prompt could be utilized. Text to speech and/or recorded prompts can also be used to inform the user of the other previously displayed information (i.e., list of assets, etc.).

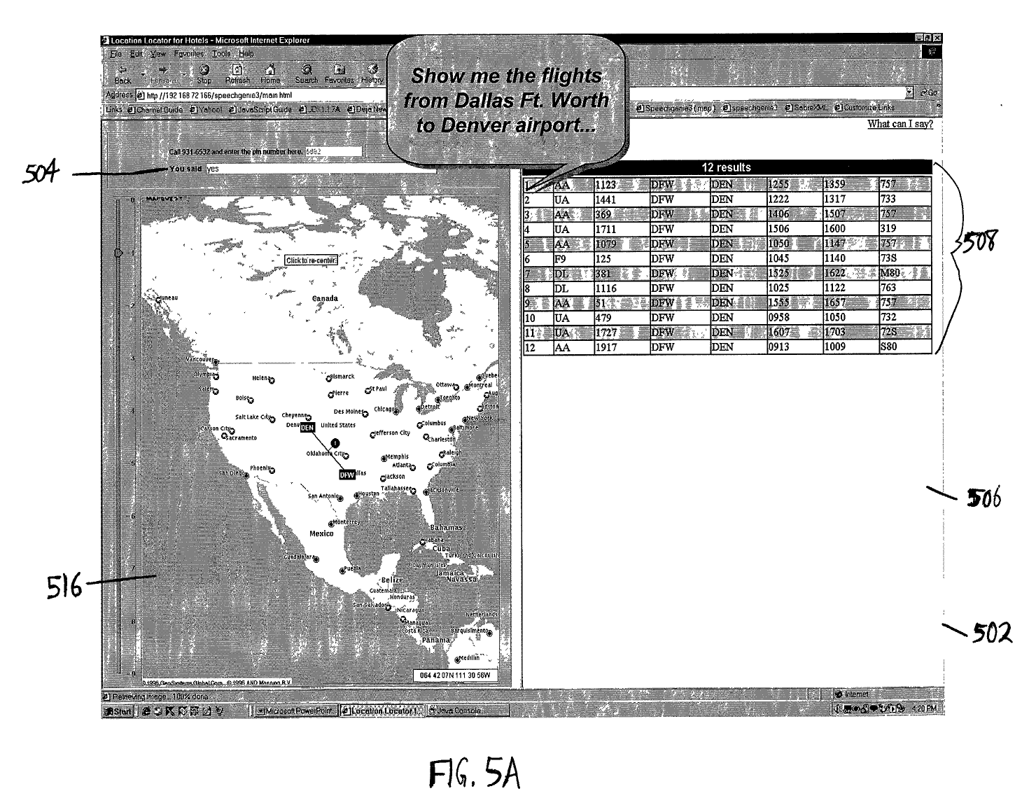

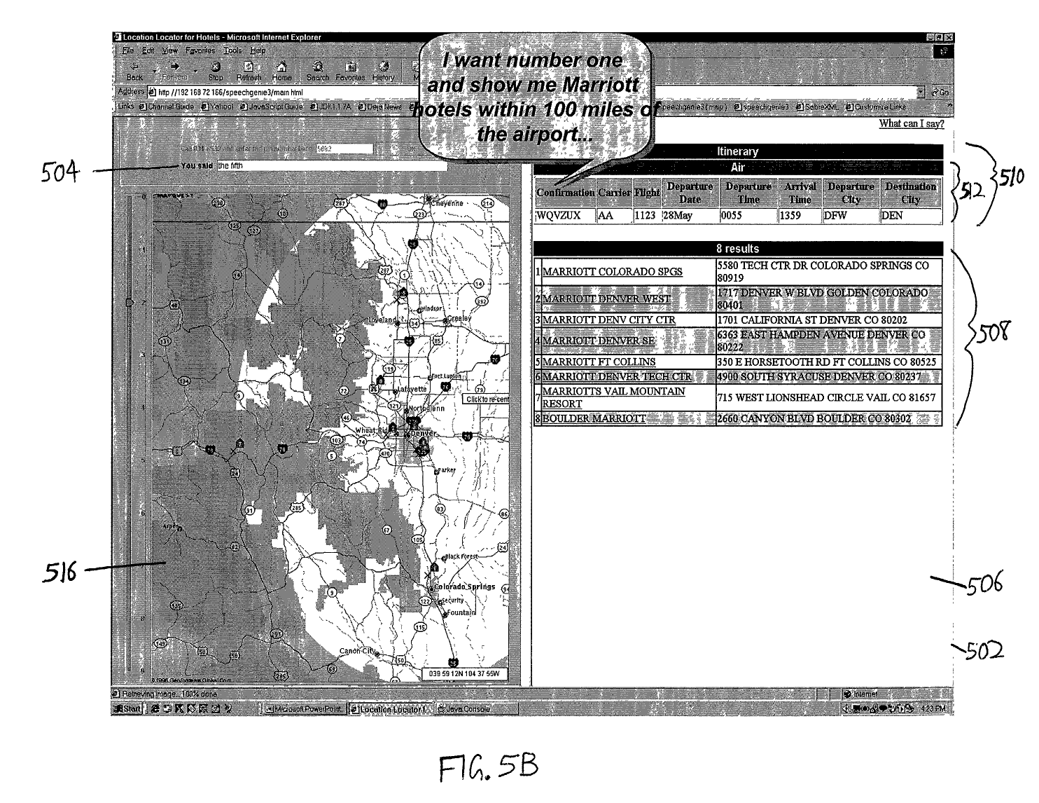

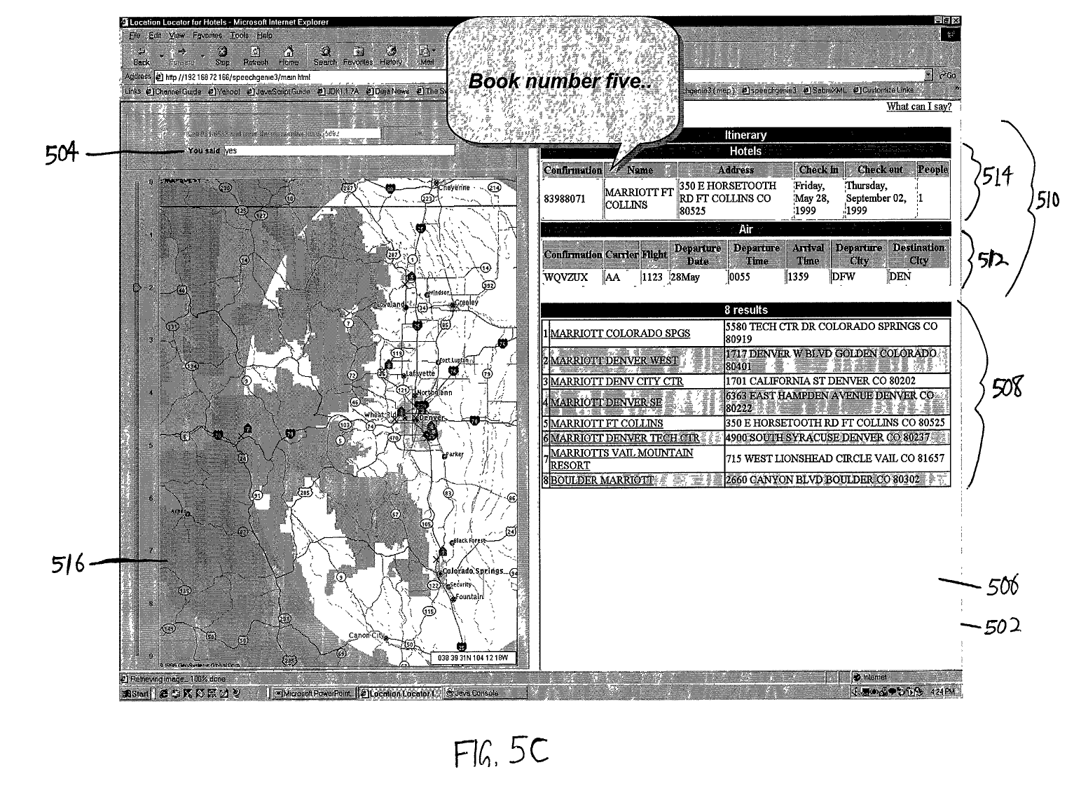

FIGS. 5A, 5B and 5C are an example of how a user might interact with the system of the present invention. After logging into the system using a web browser, the user used speech input to request the flights from the Dallas Ft. Worth airport to the Denver airport (FIG. 5A). After the user says a phrase, the system of the present invention determines exactly what was said. The phrase as it was understood by the system is displayed in “You said” box 504 on display 502 (note that the “You said” box of FIG. 5A is indicative of the user confirming what was said). Display 502 is a part of workstation 303. After the system has properly understood the user's phrase, the geo-spatial search based on that phrase can begin. The search result data of the geo-spatial search is then sent back to the workstation for display. This result data is generally shown in results list 508 which is part of lists window 506. In the example shown in FIG. 5A, the system found twelve flights from Dallas Ft. Worth to Denver Airport, and these flights are displayed in results list 508. A map corresponding to the result data is shown in map window 516.

FIG. 5B shows the next part of the example. The user, upon reviewing the results, selected number one and requested to see the Marriott hotels within 100 miles of the airport. The user's selection of number one is indicated in air section 512 which is part of itinerary 510. Itinerary 510 shows all of the assets that have actually been selected by the user. Map window 516 shows a map corresponding to the Marriott hotels within 100 miles of the Denver airport.

FIG. 5C shows the last part of the example. After looking at the list of Marriott hotels that met the search criteria, the user chose to book number five. As a result, itinerary 510 is updated to include hotels section 514 which is indicative of the Marriot (e.g., number five) booked by the user. In a similar manner, other assets and other types of assets can be searched for and displayed in the same session.

While the present invention has been described in connection with a preferred embodiment, many modifications will be readily apparent to those skilled in the art, and this application is intended to cover any adaptations or variations thereof. This invention should be limited only by the claims and equivalents thereof.

What is claimed is:

1. A method for processing travel-related speech input in a network having a travel server, the method comprising the steps, performed by the travel server, of:
receiving a speech input corresponding to a travel-related task;
converting the speech input into data reflecting the travel-related task;
accessing a database for stored information corresponding to the travel-related task; and
returning the stored information.

2. The method of claim 1, said converting step further comprising:
parsing the speech input to get required values;
determining whether all of the required values were received; and
determining whether any ambiguities exist in the speech input.

3. The method of claim 2, wherein the required values are selected from a group including type of asset, reference points, geographic operations, Boolean operations, and asset qualifiers.

4. The method of claim 2, said accessing step further comprising:
performing a search of the database based on the required values to retrieve asset data; and
sending the asset data to a computerized reservation system to check availability.

5. The method of claim 4, said accessing step further comprising:
retrieving map data from the database based on the asset data.

6. The method of claim 1, said returning step further comprising:
returning speech output in addition to the stored information.

7. An apparatus for processing travel-related speech input comprising:
means for receiving a speech input corresponding to a travel-related task;
means for converting the speech input into data reflecting the travel-related task;
means for accessing a database for stored information corresponding to the travel-related task; and
means for returning the stored information.

8. The apparatus of claim 7, said means for converting further comprising:
means for parsing the speech input to get required values;
means for determining whether all of the required values were received; and
means for determining whether any ambiguities exist in the speech input.

9. The apparatus of claim 8, wherein the required values are selected from a group including type of asset, reference points, geographic operations, Boolean operations, and asset qualifiers.

10. The apparatus of claim 8, said means for accessing further comprising:
means for performing a search of the database based on the required values to retrieve asset data; and
means for sending the asset data to a computerized reservation system to check availability.

11. The apparatus of claim 10, said means for accessing further comprising:
means for retrieving map data from the database based on the asset data.

12. The apparatus of claim 7, said means for returning further comprising:
means for returning speech output in addition to the stored information.

13. A user interface for providing travel-related information, comprising:
a first view showing text indicative of a speech input corresponding to a travel-related task, wherein the speech input is received by a travel server connected to the user interface and converted into data reflecting the travel-related task;
a second view showing stored information corresponding to the travel related task, wherein the travel server accessed a database to retrieve the stored information and returned the stored information to the user interface; and
a third view showing a map corresponding to the stored information.

14. A method for processing purchase-related speech input in a network having a server, the method comprising the steps, performed by the server, of:
receiving a speech input corresponding to a purchase-related task;
converting the speech input into data reflecting the purchase-related task;
accessing a database for stored information corresponding to the purchase-related task; and
returning the stored information.
